(19) United States
(12) Patent Application Publication
(10) Pub. No.: US 2018/0163427 A1
(43) Pub. Date: Jun. 14, 2018

(54) UMBRELLA SYSTEM WITH SOLAR POWERED DEVICE CHARGING STATION

(71) Applicant: Kenneth Bauldree, Doylestown, PA (US)

(72) Inventor: Kenneth Bauldree, Doylestown, PA (US)

(21) Appl. No.: 15/842,302

(22) Filed: Dec. 14, 2017

Related U.S. Application Data
(60) Provisional application No. 62/434,150, filed on Dec. 14, 2016.

(51) Int. Cl. E04H 15/02; H02S 20/30; H01R 25/00; H02J 7/35; H02J 7/00; H02J 7/02; E04H 15/28

(52) U.S. Cl. CPC E04H 15/02; H02S 20/30; H01R 25/006; E04H 15/28; H02J 7/007; H02J 7/025; H02J 7/355

(57) ABSTRACT

An umbrella system with integrated charging station includes an umbrella having a central pole, a canopy and a base member. A plurality of solar panels are disposed along the outside facing surface of the canopy for converting sunlight into electricity. A charging station is positioned along a middle portion of the central pole, and includes a battery, a plurality of power receptacles, and a controller. The controller including functionality for regulating the charge of the system batteries, for providing an electrical discharge based on a detected voltage requirement of a connected device, and for providing induction charging. A plurality of additional batteries are disposed within the main body of the umbrella base, and are electrically connected to the charging station and the plurality of solar cells in a removable manner.

### CROSS-REFERENCE TO RELATED APPLICATIONS

This application claims the benefit of U.S. Application Ser. No. 62/434,150 filed on Dec. 14, 2016, the contents of which are incorporated herein by reference.

### TECHNICAL FIELD

The present invention relates generally to solar power, and more particularly to an umbrella system with an integrated solar powered device charging station.

### BACKGROUND

The statements in this section merely provide background information related to the present disclosure and may not constitute prior art.

Owing to recent advancements in technology, the use of portable electronic devices such as smartphones, music players and tablets, for example, has grown exponentially. As such, it is increasingly rare for an individual to be without at least one electronic device on their person at any time. In this regard, many individuals routinely utilize their electronic devices while sitting at an outdoor table or other such setting.

Indeed many businesses routinely place outdoor tables for use by customers and/or employees, and depending on the geographic location in which the user resides, the most popular outdoor table is often one that provides some form of shade. Therefore it is not uncommon to find picnic-style tables that are equipped with an umbrella to provide a comfortable location for user to sit. Unfortunately, it is also uncommon to find any type of reliable power source to charge a portable device at these outdoor locations, as it is expensive to run power lines and electrical outlets that are connected to a commercial electrical grid. Therefore, when the power level of the user's device becomes low or exhausted, the user must typically leave the comfort of the table to find a power outlet.

Accordingly, it would be beneficial to provide an improved umbrella system having an integrated solar powered charging station that can provide an electric charge for any type of portable electronic device.

### SUMMARY OF THE INVENTION

The present invention is directed to an umbrella system with integrated charging station. One embodiment of the present invention can include an umbrella having a central pole, a canopy and a base member. A plurality of solar panels can be disposed along the outside facing surface of the canopy and can function to convert sunlight into electricity. A charging station can be positioned along a middle portion of the central pole. The charging station including a plurality of receptacles for engaging the power cords of a portable electronic device to provide the electrical power thereto.

In one embodiment of the present invention, the charging station can include functionality for regulating the charge of the system batteries, and can provide an electrical discharge based on a detected voltage requirement of a connected device. The charging station can also function to provide induction charging to an electronic device that is positioned along a top shelf of the housing.

In another embodiment, a plurality of batteries can be disposed within the main body of the umbrella base. The batteries can be electrically connected to the charging station and the plurality of solar cells in a removable manner.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a frontal view of an umbrella system with solar powered device charging station that is useful for understanding the inventive concepts disclosed herein.

FIG. 2 is a top view of the canopy portion of the umbrella system, in accordance with one embodiment of the invention.

FIG. 3 is a front view of the charging station of the umbrella system, in accordance with one embodiment of the invention.

FIG. 4 is a perspective view of the umbrella base of the umbrella system, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

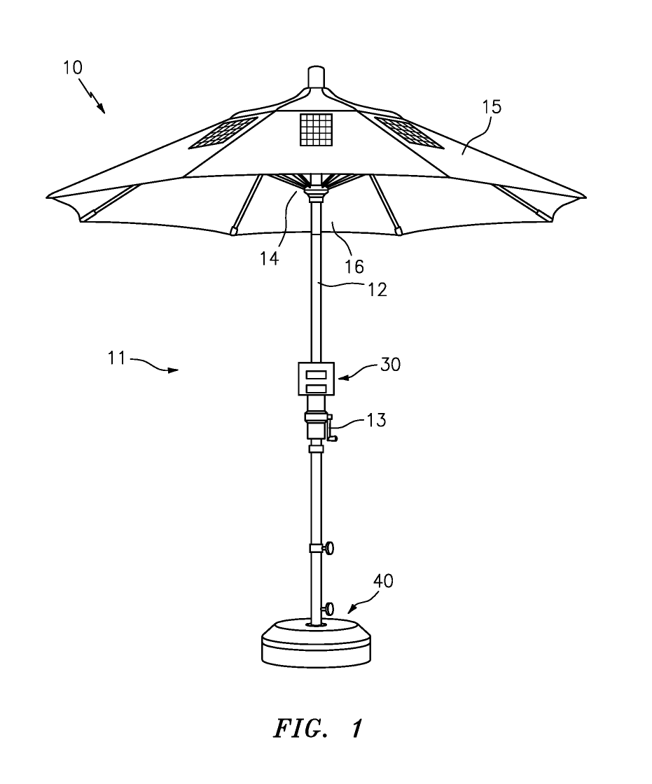

Various embodiments of an umbrella system with an integrated solar powered charging station 10 are provided throughout the drawings to aid in understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

As shown in FIGS. 1-4, the umbrella system 10 can include, essentially, a patio-style umbrella 11 having a plurality of solar panels 21 that are electrically connected to a charging station 30.

As described herein, the umbrella 11 can include a central pole 12 having a crank mechanism 13 that is in communication with a rib assembly 14 that selectively transitions between an open and closed orientation. A fabric canopy 15 is secured onto the rib assembly, and an optional tilt mechanism 16 can be provided.

Of course, any number of other umbrella styles, shapes and sizes, including means for collapsing and expanding the canopy are contemplated; however, one suitable example is also described in U.S. Pat. No. 3,044,478, to Russell, the contents of which are incorporated herein by reference.

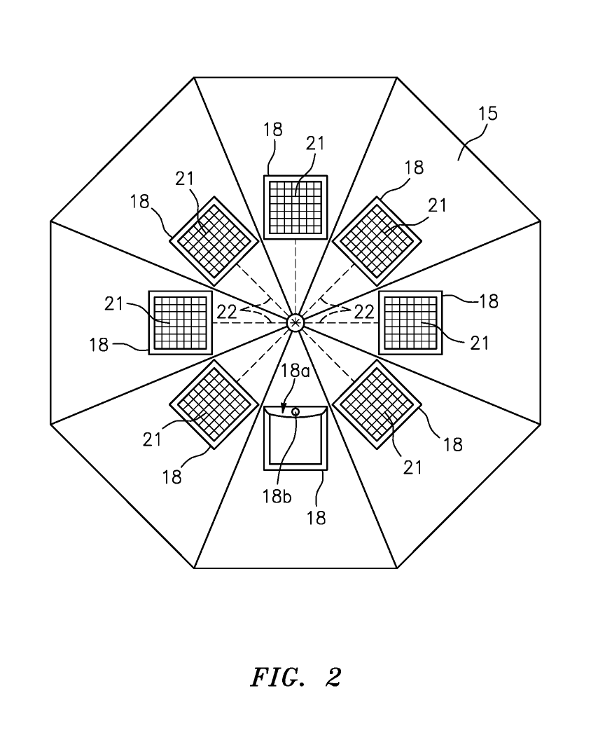

As shown in FIG. 2, a plurality of solar panels 21 can be secured along the outside facing portion of the umbrella canopy 15. It is preferred that the array of panels be arranged 360 degrees about the central pole 12, so as to allow the system to receive sunlight regardless of the orientation of the sun to the umbrella. As described herein, each of the solar panels can include, comprise or consist of any number and/or type of photovoltaic cells capable of converting sunlight into electricity.

In the preferred embodiment, each of the panels can comprise mono crystalline silicone cells that are laminated with weatherproof shields, such as tempered glass, for example, that produce an electrical output of 12 volts at 20 watts. Each of the panels can be electrically connected to the below described batteries and/or charging station via electrical wires 22 that are preferably routed through the central pole 12 so as to not be visible to a device user.

In one embodiment, a plurality of pockets 18 can be positioned equidistantly along the outside facing portion of the canopy 15. Each of the pockets including an opening 18a along the top end for receiving an individual solar panel, and an aperture 18b through which the solar panels electrical wire 22 can be routed. As shown, each of the pockets 18 can include a shape and size that is complementary to the shape and size of a solar panel, so as to allow the edges/corners of the pocket to engage the outer periphery of the individual solar panel, to hold the same in place. Such a feature advantageously allows each individual panel 21 to be removed and replaced if/when a failure occurs. Of course, other embodiments are contemplated wherein the panels 21 can be permanently affixed to the canopy utilizing stitching or adhesives, for example.

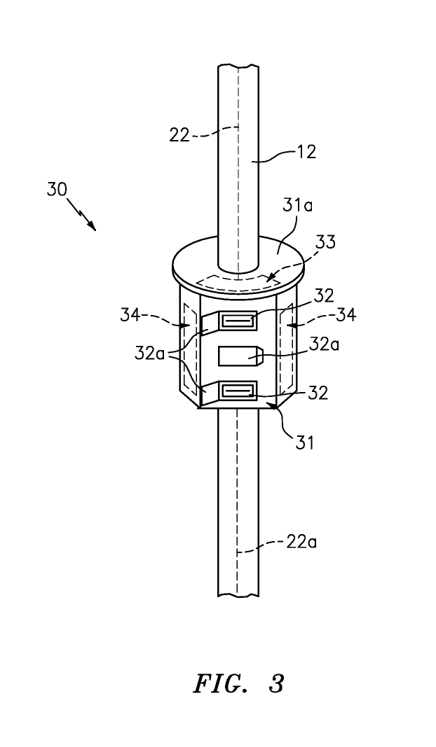

FIG. 3 illustrates one embodiment of the charging station 30. As shown, the station can include a housing 31 having a plurality of receptacles 32 along one or more sides, that are connected to an internal charge controller 33, and one or more batteries 34.

As described herein, the housing 31 can include any number of different shapes and sizes, and can be constructed from any number of different materials that are suitable for prolonged exposure to adverse weather conditions (e.g., rain, dirt and snow,), such as plastic or metal, for example. The housing 31 can be physically connected to the central pole 12 at any location via fasteners (not illustrated) of through other known manufacturing means. In one embodiment, the top of the housing can extend outward from the vertical portion of the housing body, and can include a shape that extends 360 degrees around the central pole 12 forming a generally circular shelf portion 31a. The shelf portion can provide a convenient location for a user to store a smartphone or other electronic device while it is being charged.

Each of the receptacles 32 can function to supply power to a portable electronic device. In one embodiment, each of the receptacles can include, comprise or consist of a Universal Serial Bus (USB) connection port for receiving a conventional USB power plug, and providing direct current (DC) power thereto. In the preferred embodiment, each of the receptacles 32 can be recessed within the surface of the housing and can be protected by a waterproof shield 32a that can transition between an open and closed position to selectively cover the receptacle. Such a feature can prevent water and dirt from getting into the power receptacles.

Of course, other embodiments are contemplated wherein the receptacles include or comprise different types of ports for engaging power cables with configurations other than USB. To this end, any number or type of receptacles can be provided along the housing 31 and/or the central pole 12, so as to be able to provide the necessary power requirements for one or more portable electronic devices or other such objects connected thereto.

The controller 33 can be positioned within the housing 31 and can be electrically connected to both the solar panels 21 and the batteries 34 via the electrical wires 22. Although illustrated as a single component, the controller can include, comprise or consist of any number of different components capable of performing the functionality described herein. For example, the controller can include a charge regulator that functions to maintain the proper charging voltage for the system batteries 34 and/or 44, and can regulate the output of each of the receptacles 32.

In one embodiment, the charge controller can function to automatically sense the voltage requirements of a connected user device, and can automatically adjust the output DC voltage of the receptacle to the necessary voltage. Such a feature advantageously allows users to charge one or more devices having different power requirements.

In one embodiment, the controller can also include an optional inverter that is connected to one or more A/C power outlets, in order to provide alternating current thereto. To this end, the controller can also include functionality for performing wireless or induction charging of a portable device by including a pair of induction coils capable of generating an electromagnetic field that transfers energy from the controller to a portable electronic device resting on the shelf portion of the housing 31a, without requiring the portable device to be physically plugged in. In such an embodiment, the coils will preferably be located directly beneath the shelf 31a.

In one embodiment, a plurality of batteries 34 can be positioned within an accessible cavity of the housing 31, so as to be accessible for replacement if/when necessary. In the preferred embodiment, the batteries 34 can comprise Lithium Ion rechargeable batteries; however, other embodiments are contemplated wherein a different type of batteries and/or location of batteries are utilized.

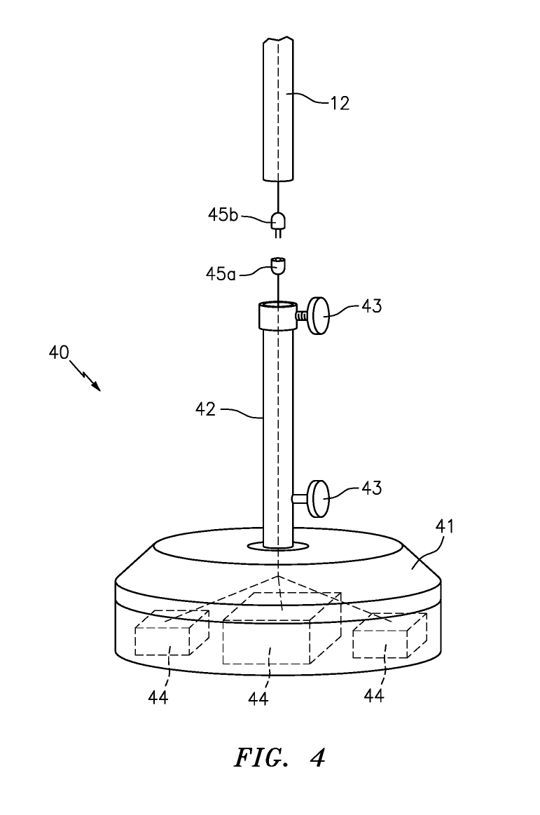

As shown in FIG. 4, one embodiment, the umbrella system 10 can further include an umbrella base 40. The base can include a main body 41 having a channel 42 with fasteners 43 for receiving and engaging the bottom end of the central pole 12. In the preferred embodiment, the base can include a weight of between 5 and 20 pounds that is centrally located within the body 41, so as to prevent movement of the umbrella 11 connected thereto.

In one embodiment, the weight can be in the form of a plurality of additional rechargeable batteries 44, that are positioned within the main body 41, and electrically connected to the charging station via electrical wires 22a. The wires 22a including quick connect electrical fittings 45a and 45b, for allowing the additional batteries to be disconnected from the station when the base is removed. To this end, when the fittings 45a and 45b are connected, and the bottom end of the pole 12 is secured within the channel 42, the wires 22a and fittings can be housed within the base. Therefore, by substituting the (typically sand or concrete) weights of the umbrella base with a plurality of batteries, the system is able to advantageously generate and store vast amounts of electrical power compared with other known forms of solar charging equipment.

As described herein, each of the batteries 34 and 44 can include, comprise or consist of any type of battery in any orientation (e.g., parallel, series, etc.,) that can function to store electrical power that is generated by the solar panels and that can provide the same to the charging station. Several nonlimiting examples include Nickel Cadmium (NiCd) batteries, Nickel-Metal Hydride (NiMH) batteries, Lead Acid batteries and/or Lithium Polymer batteries, for example.

As described herein, one or more elements of the umbrella system 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. An umbrella system, comprising:
a central pole having a top end, a bottom end, and a middle portion;
a canopy and rib assembly that is secured along the top end of the central pole;
a plurality of solar panels that are disposed along an outside facing portion of the canopy;
a charging station housing that is disposed along the middle portion of the central pole;
a plurality of receptacles that are disposed along the charging station housing;
at least one battery that is disposed within the charging station housing; and
a controller that is disposed within the charging station housing, said controller being electrically connected to each of the plurality of solar panels, the at least one battery and the plurality of receptacles via electrical wires.

2. The umbrella system of claim 1, wherein the plurality of solar panels are disposed along an outside facing surface of the canopy in a 360 degree orientation relative to the central pole.

3. The umbrella system of claim 1, wherein the housing is permanently affixed to the central pole; and
wherein the electrical wires are routed through an interior portion of the central pole.

4. The umbrella system of claim 1, wherein the plurality of receptacles includes at least one universal serial bus connection port that is configured to discharge electrical direct current.

5. The umbrella system of claim 1, further comprising:
a plurality of waterproof shields that are disposed along the charging station housing, each of the waterproof shields being positioned about one of the plurality of receptacles.

6. The umbrella system of claim 5, wherein each of the waterproof shields is configured to transition between an open configuration for allowing access to a receptacle, and a closed configuration for preventing access to a receptacle.

7. The umbrella system of claim 1, wherein the controller includes a charge regulator that is configured to regulate a charging voltage of the at least one battery.

8. The umbrella system of claim 7, wherein the controller includes functionality for detecting a voltage requirement of an electronic device that is connected to one of the plurality of receptacles, and regulating an electrical discharge of the receptacle to match the detected voltage requirement.

9. The umbrella system of claim 1, further comprising:
a shelf that is positioned along a top end of the charging station housing.

10. The umbrella system of claim 10, wherein the controller includes a pair of induction coils that are positioned directly beneath the shelf, said coils being configured to provide an induction charge to an electronic device positioned on the shelf.

11. The umbrella system of claim 1, further comprising:
an umbrella base having a main body and a pole receiving channel that is configured to engage the bottom end of the central pole.

12. The umbrella system of claim 11, further comprising:
a plurality of additional batteries that are positioned within the main body of the umbrella body, said additional batteries including a weight of between 5 and 20 pounds.

13. The umbrella system of claim 12, wherein each of the plurality of additional batteries are electrically and removably connected to the charging station.
